(19) United States
(12) Patent Application Publication
(10) Pub. No.: US 2026/0229941 A1
(43) Pub. Date: Aug. 6, 2026

(54) ROTOR FOR ROTARY ELECTRIC MACHINE, METHOD FOR MANUFACTURING ROTOR FOR ROTARY ELECTRIC MACHINE, ROTARY ELECTRIC MACHINE, AND ELECTRIC VEHICLE USING ROTARY ELECTRIC MACHINE

(71) Applicant: Mitsubishi Electric Mobility Corporation, Tokyo (JP)

(72) Inventors: Satoru SATO, Tokyo (JP); Kohei YASUDA, Tokyo (JP); Yoshiki KUWAHARA, Tokyo (JP)

(73) Assignee: Mitsubishi Electric Mobility Corporation, Tokyo (JP)

(21) Appl. No.: 19/151,780

(22) PCT Filed: May 29, 2023
(86) PCT No.: PCT/JP2023/019845

§ 371 Date: Jul. 29, 2025

(51) Int. Cl. H02K 1/28; H02K 1/276; H02K 1/278; H02K 15/035; H02K 15/12

(52) U.S. Cl. CPC H02K 1/28; H02K 1/276; H02K 1/278; H02K 15/035; H02K 15/12

(57) ABSTRACT

A plurality of magnet slots are provided along the circumferential direction of a rotor core in which a plurality of electromagnetic steel plates are stacked. Permanent magnets are stored in the magnet slots, and are adhesively fixed to the inner wall surface of the magnet slots via magnet fixing resin. And work oil is present at the adhesive surface between the rotor core and the magnet fixing resin, and the work oil is present over the entire inner wall surface of the magnet slots.

### TECHNICAL FIELD

The present disclosure relates to a rotor for a rotary electric machine, method for manufacturing the rotor for the rotary electric machine, the rotary electric machine, and an electric vehicle using the rotary electric machine.

### BACKGROUND ART

In permanent magnet motors (hereafter referred to as PM (PERMANENT MAGNET) motors) that use permanent magnets as a field magnet, electrification of automobiles is improved, and it is required to be more efficient and to have greater output in accordance with recent technological advances in industrial robots and railways. In PM motors, permanent magnets are installed in a rotor, and a stator placed around it is configured by electromagnets in which coils are wound. A rotating magnetic field is created by passing a three-phase alternating current through the coils, and the rotor rotates in response to this. PM motors are schematically divided into two types, that is, surface magnet type (SPM: SURFACE PERMANENT MAGNET) in which the magnets are incorporated on the surface of the rotor, and magnet embedded type (IPM: INTERIOR PERMANENT MAGNET) in which the magnets are incorporated inside the iron core of the rotor. In SPM motors, it is able to use effectively the magnetic flux density of the magnet. On the other hand, in IPM motors, because of their structure in which the magnets are embedded, mechanical stability is higher, and rotation speed is higher than SPM motors. As another feature, it is able to utilize reluctance torque.

Various methods have been considered in order to fix the magnets of the PM motor to the iron core of the rotor. For example, there is a method for improving durability by optimizing the expansion coefficient at high temperatures through devising a composition of the thermosetting resin filled in the magnet holes of the IPM rotor iron core (see Patent Document 1).

In addition, there is a configuration in which a plurality of protrusions having a height equal to the thickness of the adhesive layer used in order to adhere the magnet are provided on the surface of the rotor core, i.e., on the magnet adhering surface (see Patent Document 2).

### PRIOR TECHNICAL DOCUMENTS

### Patent Document

Patent Document 1: Japanese Patent No. 6275946

Patent Document 2: Japanese Laid-Open Patent Publication No. 2021-87237

### SUMMARY OF THE INVENTION

### Problems to be Solved by the Invention

Rotors are used while rotating at high speeds for long periods of time under high temperatures. There is a strong demand for miniaturization of motors, but to achieve this, it is necessary to develop motors that can rotate at even higher speeds. When the motor rotates at high speed, a large centrifugal force acts on the permanent magnets attached to the rotor core. It is necessary to have a structure that prevents the magnets from shifting, deforming and breaking, even when centrifugal force is applied. In order to realize such a structure, an important technical challenge is to optimally design a method for fixing the permanent magnets to the rotor core.

The present disclosure has been made to solve the above problems, and the object is to provide a highly reliable rotary electric machine capable of firmly fixing permanent magnets to a rotor core.

### Means to Solve the Problems

A rotor for a rotary electric machine according to the present disclosure has a rotor core made of multiple stacked electromagnetic steel plates and a permanent magnet fixed to the rotor core via a magnet fixing resin, and work oil is present on the adhesive surface between the rotor core and the magnet fixing resin.

In a method for manufacturing the rotor for the rotary electric machine according to the present disclosure, a process of applying the work oil as a surface treatment to the entire surface of the rotor core is provided prior to a process of adhesively fixing the permanent magnets to the rotor core.

The rotary electric machine according to the present disclosure comprises the rotor configured as described above and a stator disposed on an outer periphery of the rotor.

An electric vehicle according to the present disclosure uses the rotary electric machine as described above.

### Effect of the Invention

According to a rotor for a rotary electric machine and a method for manufacturing the rotary electric machine disclosed in the present application, it is possible to provide a highly reliable rotating electric machine in which permanent magnets can be firmly fixed to the rotor core.

### BRIEF DESCRIPTION OF THE DRAWINGS

FIG. 1 is a plane sectional view showing a rotary electric machine of an IPM motor according to embodiment 1.

FIG. 2 is a plane sectional view showing a rotor portion of an IPM motor according to embodiment 1.

FIG. 3 is a plane sectional view showing a rotary electric machine of an SPM motor according to embodiment 1.

FIG. 4 is a plane sectional view showing a rotor portion of an SPM motor according to embodiment 1.

FIG. 5 is a partially enlarged plane view showing a magnet slot portion of the rotor in an IPM motor according to embodiment 1.

FIG. 6 is a partially enlarged plane view showing the magnet slot portion of the rotor in the IPM motor according to embodiment 1.

FIG. 7 is a partially enlarged plane view showing the magnet slot portion of the rotor in the IPM motor according to embodiment 1.

FIG. 8 is a partially enlarged plane view showing the magnet slot portion of the rotor in the IPM motor according to embodiment 1.

FIG. 9 is a partially enlarged plane view showing a flux barrier portion of the magnet slot in the rotor for the IPM motor according to embodiment 1.

FIG. 10 is a partially enlarged plane view showing the state in which a work oil has been applied to the magnet slot portion of the rotor for the IPM motor according to embodiment 1.

FIG. 11 is a partially enlarged plane view showing the state in which the work oil has been applied to the magnet slot portion of the rotor for the IPM motor according to embodiment 1.

FIG. 12 is a partially enlarged plane view showing the state in which the work oil has been applied to the magnet slot portion of the rotor for the IPM motor according to embodiment 1.

FIG. 13 is an enlarged sectional view of the magnet slot portion of the rotor for the IPM motor according to embodiment 1.

FIG. 14 is an enlarged sectional view of the magnet slot portion of the rotor for the IPM motor according to embodiment 1.

FIG. 15 is a table showing the relationship between each sample and shear strength.

FIG. 16 is a schematic diagram showing the drive system of a hybrid automobile in which the IPM motor according to embodiment 1 is installed in the engine.

### EMBODIMENTS FOR CARRYING OUT THE INVENTION

### Embodiment 1

This embodiment relates to a rotary electric machine and a rotor for the rotary electric machine, which require high precision control in fields such as automobiles and railways.

Hereafter, an embodiment of the rotary electric machine according to this embodiment will be described with reference to the drawings. In the following description, the various directions in the rotary electric machine are respectively the circumferential direction, the axial direction of the rotating shaft of the rotor for the rotary electric machine, and the radial direction. Further, in the rotor, these directions are the same, and each direction will be indicated based on these directions.

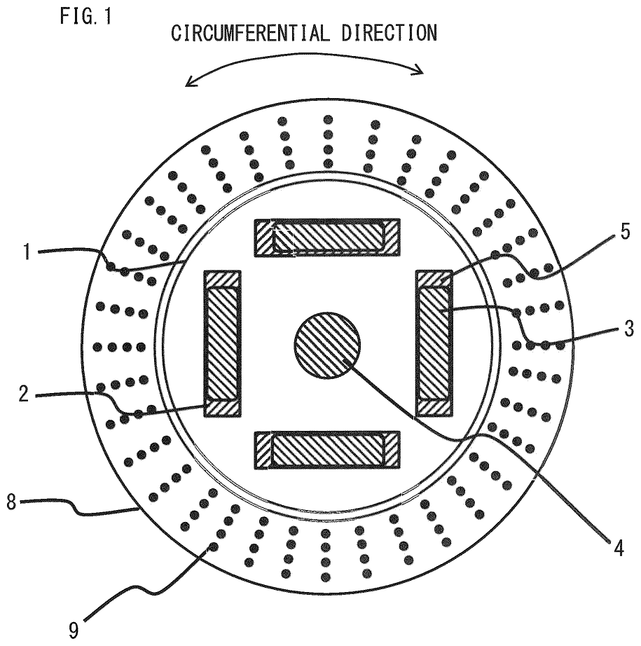

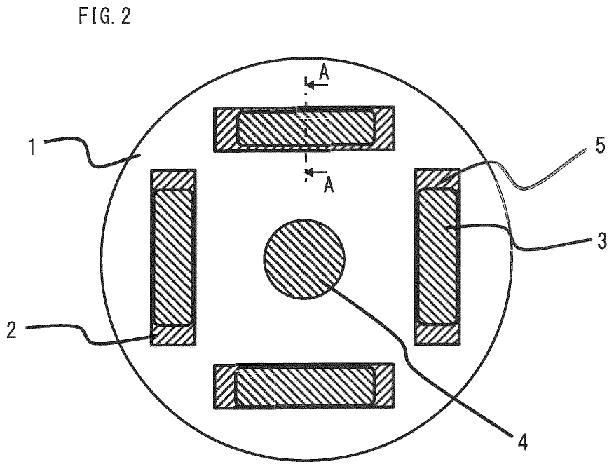

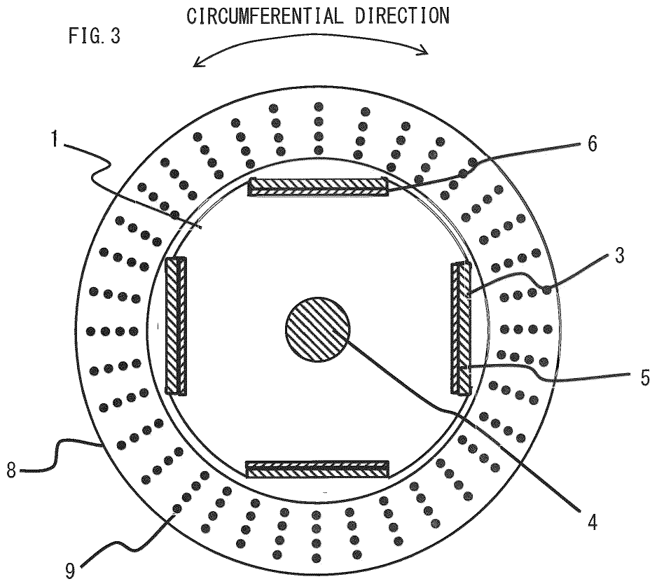

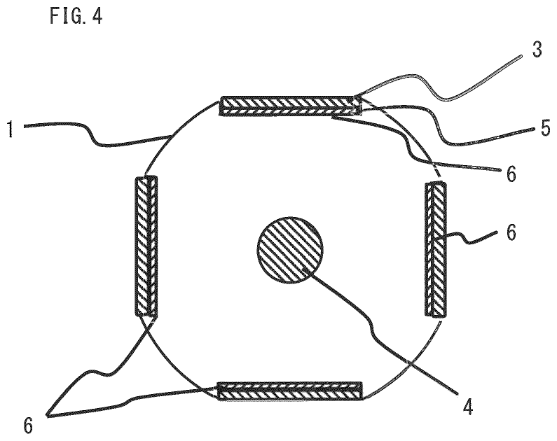

FIG. 1 is a plane sectional view showing a rotary electric machine as an IPM motor according to this embodiment, and FIG. 2 is a plane sectional view showing a rotor portion of the IPM motor. FIG. 3 is a plane sectional view showing a rotary electric machine as an SPM motor according to this embodiment, and FIG. 4 is a plane sectional view showing a rotor portion of the SPM motor. As shown in FIGS. 1 and 2, the rotor for the IPM motor has a rotor core 1 formed by stacking a plurality of electromagnetic steel plates, and permanent magnets 3 embedded in magnet slots 2 provided in the rotor core 1. Further, a shaft slot 4 is provided in the center of the rotor core 1. A plurality of magnet slots 2 are provided so as to axially penetrate the rotor core 1, and provided along the circumferential direction of the rotor core 1. It is noted that although FIGS. 1 and 2 show an example of a four-pole rotor in which the number of magnet slots 2 is four and four permanent magnets 3 are embedded in the magnet slots 2, the number of poles of the rotor is not particularly limited.

As shown in FIGS. 3 and 4, the rotor for the SPM motor of this embodiment has a rotor core 1, magnet fixing portions 6 provided on the outer periphery of the rotor core 1, and permanent magnets 3 fixed to the magnet fixing portions 6. A shaft slot 4 is provided in the center of the rotor core 1. A plurality of magnet fixing portions 6 are provided along the circumferential direction of the rotor core 1. It is noted that FIGS. 3 and 4 show an example of a four-pole rotor in which the number of magnet fixing portions 6 is four and four permanent magnets 3 are embedded in the magnet fixing portions 6. But the number of poles of the rotor is not particularly limited.

In FIGS. 1 to 4, the permanent magnets 3 are fixed to the magnet slots 2 or magnet fixing portions 6 via magnet fixing resin 5. The magnet fixing resin 5 may be any resin that has fluidity when filled and can harden in order to fix the permanent magnets 3 when the rotor is used, and a thermosetting resin such as an epoxy resin can be used. There is no particular limitation with respect to the method for filling the magnet fixing resin 5, and any method known in the technical field can be used. Examples include a method for applying the resin only to the portion in which the permanent magnet 3 is assembled, a method for pouring the resin directly from the top of the magnet slot 2, and a method for pouring the resin pressurizing by using a mold with a pouring port.

The IPM motor or SPM motor according to this embodiment is manufactured by incorporating the rotor configured as described above into a stator, as shown in FIGS. 1 and 3. The stator is manufactured by inserting stator windings 9 into stator core 8. The stator core 8 can be formed by stacking electromagnetic steel sheets in the same manner as the rotor core 1. The stator winding 9 has a conductor surface covered with an enamel coating. The conductor of the stator winding 9 is not particularly limited as long as it is conductive, and it is possible to use wires made of copper, aluminum, etc. It is preferable to use copper, which has a low resistance and generates less heat when current flows through it.

It is preferable that the enamel coating has heat-resistant of 180° C. or higher, and polyesterimide, polyamideimide, polyimide or the like can be used alone or in combination of two or more layers. The stator winding 9 may be wound around the stator core 8 by either concentrated winding or distributed winding.

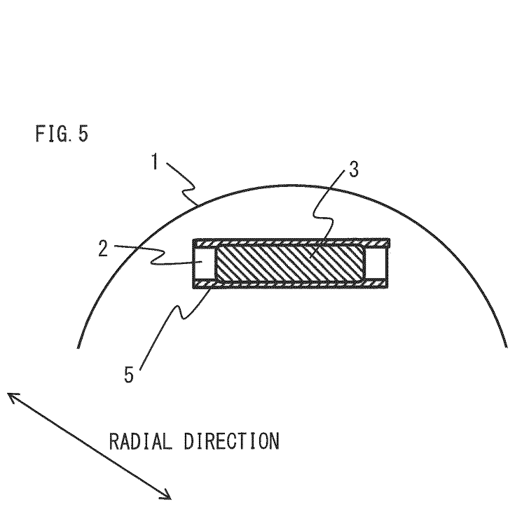

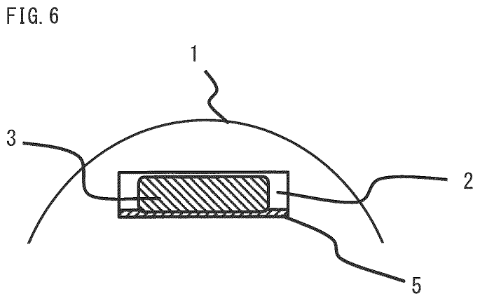

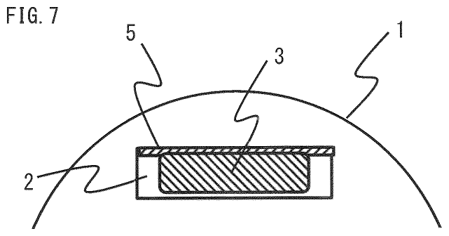

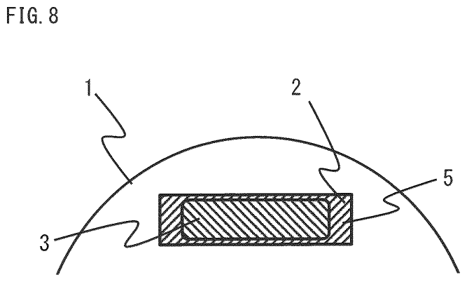

FIGS. 5 to 8 are partially enlarged plane views showing the magnet slots of the rotor in an IPM motor, and show the application form of magnet fixing resin. In the permanent magnets 3 provided in the magnet slots 2, it is enough that the magnet fixing resin 5 is applied to the parts that come into contact with the rotor core 1. In FIG. 5, magnet fixing resin 5 is applied to both radial direction side surfaces of the magnet slot 2. In FIGS. 6 and 7, magnet fixing resin 5 is applied to one radial direction side surface of the magnet slot 2. In FIG. 8, magnet fixing resin 5 is applied to both radial direction side surfaces and both circumferential direction side surfaces of the magnet slot 2. That is, the entire side surface of the permanent magnet 3 is covered with magnet fixing resin 5.

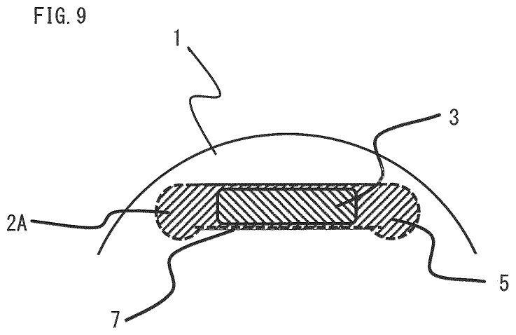

FIG. 9 is a partially enlarged plane view showing a flux barrier portion of the magnet slot 2 in the rotor for the IPM motor. The shape of the flux barrier 2A is not particularly limited. A magnet fixing resin 5 is applied to a part or the entire inner wall surface of the flux barrier 2A. Furthermore, in this embodiment, the work oil 7 is present on all or any of the surfaces of the rotor core 1, side surfaces of the rotor core 1, and spaces between the laminations of the rotor core 1. The work oil 7 is present on the inner wall surface of the flux barrier 2A. The work oil 7 is not particularly limited as long as it is used in machining, such as press oil, processing oil, cutting oil, etc. As a component, it is preferable that the oiliness agent component containing a polar group such as a carboxyl group, a hydroxyl group, or an amine is contained in a weight percentage of 1% or more, and more preferably 1 to 15%.

By configuring in this manner, in the IPM motor, it is possible to improve the shear strength between the rotor core 1 and the magnet fixing resin 5. Furthermore, it is possible to improve the shear strength not only at the interface between the rotor core 1 and the magnet fixing resin 5 provided between the rotor core 1 and the permanent magnets 3, but also at the interface between the inner wall surface of the flux barrier portion and the magnet fixing resin 5 filled in the flux barrier portion.

The method for applying the work oil 7 may be performed such that it is applied to the adhesive interface between the rotor core 1 and the magnet fixing resin 5. For example, the work oil 7 may be applied to the entire rotor core 1, between laminations, the inner wall of the magnet slot 2 in which the resin for fixing the permanent magnets 3 is present, or even to the surface of the permanent magnets 3. If the work oil 7 remains, a cleaning process or a heating process in a high-temperature furnace may be performed to the rotor core 1. If a cleaning process or a heating process in a high-temperature furnace can be performed, the work oil 7 can be applied at any time.

The magnet slots 2 are filled with magnet fixing resin 5 except for the portions occupied by the permanent magnets 3, and are configured so that the work oil 7 is present along the entire inner wall surface of the magnet fixing resin 5. In this way, a process of applying the work oil 7 to the inside of the magnet slots 2 can be carried out before the permanent magnets 3 or the magnet fixing resin 5 are inserted into the magnet slots 2, and a structure in which the work oil 7 is provided over the entire interface between the rotor core 1 and the magnet fixing resin 5 can be obtained efficiently by a relatively simple process.

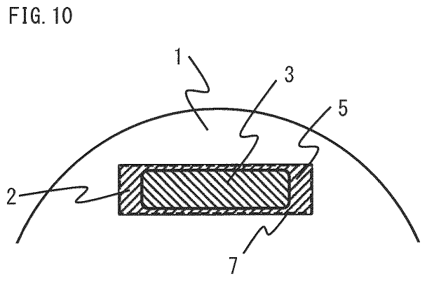

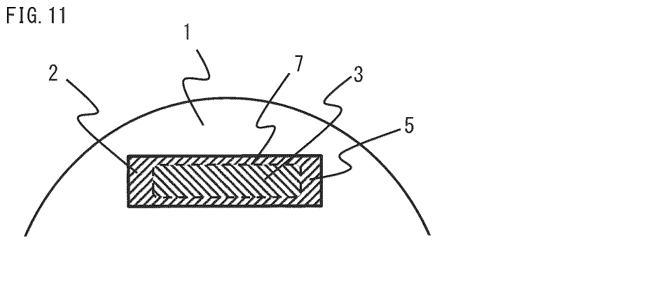

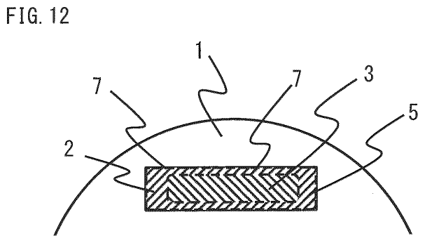

FIGS. 10 to 12 are partially enlarged plane views showing the state in which the work oil 7 has been applied to the magnet slot portion of the rotor for the IPM motor. FIG. 10 shows the state in which work oil 7 has been applied to the adhesive interface between the rotor core 1 and the magnet fixing resin 5. FIG. 11 shows the state in which work oil 7 has been applied to the adhesive interface between the permanent magnet 3 and the magnet fixing resin 5. FIG. 12 shows the state in which work oil 7 has been applied to the adhesive interface between the rotor core 1 and the magnet fixing resin 5, and the state in which work oil 7 has been applied to the adhesive interface between the permanent magnet 3 and the magnet fixing resin 5.

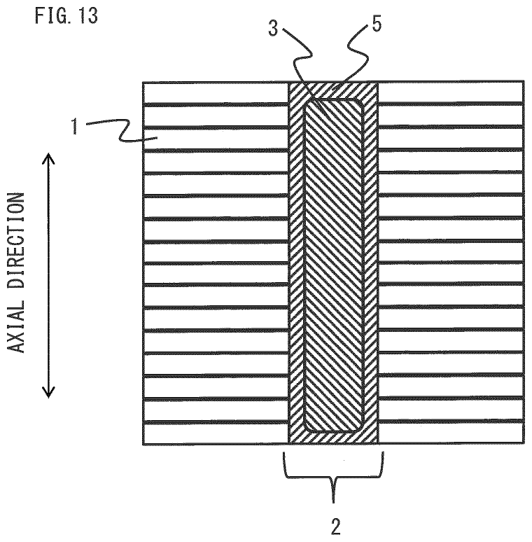

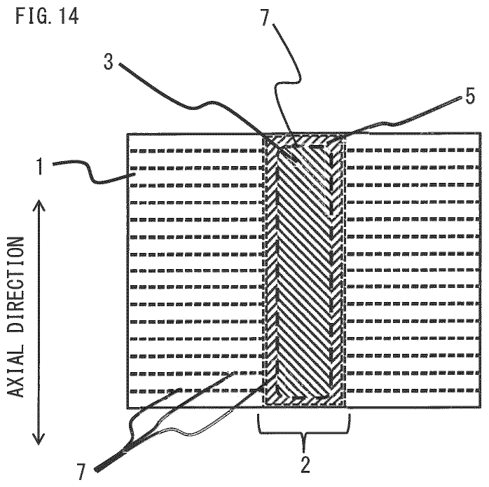

FIG. 13 is an enlarged sectional view of the magnet slot portion of the rotor for the IPM motor, and is a sectional view taken along A-A line in FIG. 2. FIG. 14 is a sectional view taken along A-A line in FIG. 2, and shows a schematic diagram of an application portion of the work oil 7. In FIG. 14, the work oil 7 is applied to all of the interface between the rotor core 1 and the magnet fixing resin 5, the interface between the permanent magnet 3 and the magnet fixing resin 5, and the interfaces between the laminations of the rotor core 1. Furthermore, the work oil 7 may be applied to any of the interface between the rotor core 1 and the magnet fixing resin 5, the interface between the permanent magnet 3 and the magnet fixing resin 5, and the interfaces between the laminations of the rotor core 1.

The magnet fixing resin 5 is heated to harden it after filling. There are no particular limitations on the heat treatment conditions for the magnet fixing resin 5, but it is sufficient if it can bond and fix the rotor core 1 and the permanent magnets 3. When using, for example, epoxy resin as the thermosetting resin, as typical hardening conditions for pouring liquid resin from an upper portion, it is sufficient to perform heating for about 30 minutes to 2 hours in a drying furnace at 100 to 160° C. When pouring resin while applying pressure by using a mold with a pouring port, injection molding can be performed in a mold temperature of 100° C. to 180° C., an injection pressure of 3 to 10 MPa, and a hardening time of about 1 to 30 minutes.

Since the work oil 7 contains polar functional groups as a component, the work oil 7 is adsorbed to the surface of the rotor core 1 to form a film of oily agent molecules. This molecular film forms hydrogen bonds with the magnet fixing resin 5, and there is an effect of improving adhesion. Therefore, there is a higher shear strength than the state in which the work oil 7 is not present.

As described above, the rotor for the rotary electric machine according to this embodiment includes the rotor core made of stacked circular electromagnetic steel sheets, and permanent magnets 3 bonded and fixed to the rotor core 1 via magnet fixing resin 5. And the work oil 7 is present on the bonding surface between the rotor core 1 and the magnet fixing resin 5. The work oil 7 improves shear strength, and the permanent magnets 3 can be firmly fixed by the magnet fixing resin 5 even in a rotor rotating at high speed.

Furthermore, the work oil 7 is present between the laminations of the electromagnetic steel sheets that form the rotor core 1, and it is able to use bonded steel sheets in which the laminations of the electromagnetic steel sheets are bonded and fixed by magnet fixing resin 5. By this way, it is possible to improve the shear strength between the stacked layers of the bonded electromagnetic steel sheets.

The materials used in the rotary electric machine according to this embodiment are described below. The rotor core 1 is not particularly limited, and can be formed by a steel sheet laminated body made by stacking electromagnetic steel sheets, and can be formed by iron or an iron-silicon alloy. The rotor core 1 can also be obtained by molding a powder magnetic core made from soft magnetic metal powder such as an iron-carbon alloy, or a magnetic powder in which soft magnetic metal oxide powder is coated by a resin binder such as silicone resin. The rotor core 1 can also be obtained by molding by a high-density powder magnetic core. The forming method is not particularly limited, and may be a method of cutting out a material, a method of stacking electromagnetic steel sheets pressed so as to become a desired shape, or the like. Among them, the rotor core 1 obtained by forming a steel sheet laminated body made by stacking silicon steel sheets is preferable, and in particular, from the viewpoint of preventing eddy current loss, the rotor core 1 obtained by forming a steel sheet laminated body made by stacking silicon steel sheets having an insulating film formed on the surface is more preferable. The thickness of the silicon steel sheets is not particularly limited, but is generally 0.2 mm to 0.5 mm.

Examples of the permanent magnet 3 include rare earth magnets, ferrite magnets, and alnico magnets. Among them, rare earth magnets that can provide high output are preferable. Examples of rare earth magnets include neodymium-iron-boron magnets and samarium-iron-nitrogen magnets. Among these, neodymium-iron-boron sintered magnets are preferable because of their excellent magnetic performance. Furthermore, in neodymium-iron-boron sintered magnets, the coercive force of the grain boundaries can be strengthened by using a diffusion method in which dysprosium, terbium, or the like is diffused along the interfaces between crystals (grain boundaries), replacing only the neodymium at the grain boundaries with dysprosium or terbium.

One sort of magnet can be selected among the above-mentioned various magnets in order to use as the permanent magnet 3. In addition, a combination of a plurality of magnets can be used to obtain desired motor characteristics of the IPM motor.

Furthermore, the permanent magnet 3 embedded in the magnet slot 2 may be a single permanent magnet 3 preliminarily formed into a predetermined shape. But from the standpoint of reducing eddy currents or temperature, it may be possible to use a permanent magnet 3 divided into several pieces, or it may be possible to use a structure in which permanent magnets 3 divided into several pieces are joined together so as to form an integrated magnet. It may also be possible to use a permanent magnet 3 with slits. By dividing the permanent magnet or adding slits, the effect of reducing losses due to eddy currents can be obtained.

It is preferable to use a thermosetting resin as the magnet fixing resin 5 so that it can fill the gap between the rotor core 1 and the permanent magnet 3. Examples of thermosetting resins include epoxy resin, acrylic resin, phenolic resin, and silicone resin. These resins can be used alone or in combination of two or more sorts. But among them, acrylic resin and epoxy resin are preferable in view of heat resistance, adhesiveness, chemical resistance, and electrical properties, and epoxy resin is particularly preferable. It is noted that epoxy resin is made of an epoxy compound having two or more epoxy groups per one molecule.

Specific examples of the epoxy resin include heterocyclic epoxy resins such as bisphenol A type epoxy resins, brominated bisphenol A type epoxy resins, hydrogenated bisphenol A type epoxy resins, bisphenol F type epoxy resins, bisphenol S type epoxy resins, bisphenol AF type epoxy resins, biphenyl type epoxy resins, naphthalene type epoxy resins, fluorene type epoxy resins, novolac type epoxy resins, phenol-novolac type epoxy resins, orthocresol-novolac type epoxy resins, tris(hydroxyphenyl)methane type epoxy resins, dicyclopentadiene type epoxy resins, glycidyl ester type epoxy resins such as tetraphenylolethane type epoxy resins, glycidyl ester type epoxy resins obtained by condensation of epichlorohydrin and carboxylic acid, and hydantoin type epoxy resins obtained by reaction of dantoin-kind and triglycidyl isocyanate or epichlorohydrin.

When an epoxy resin is used, a curing agent and a curing accelerator for the epoxy resin may be used together according to the needs. The curing agent for the epoxy resin reacts chemically with the epoxy resin to cure the epoxy resin. As such a curing agent, any agent capable of curing an epoxy resin can be used appropriately, and the sort is not particularly limited. Examples of the curing agent include amine-type curing agents such as ethylenediamine and polyamidoamine, and acid anhydride-type curing agents such as phthalic anhydride, hexahydrophthalic anhydride, 4-methylhexahydrophthalic anhydride, tetrahydrophthalic anhydride, 4-methyltetrahydrophthalic anhydride, and tetrabromophthalic anhydride. Further examples of the hardener include phenol novolac resins such as phenol novolac, orthocresol novolac, or bisphenol A novolac, and phenol (biphenyl aralkyl) resins such as phenol aralkyl and biphenyl aralkyl. Further examples of the hardener include phenol-type hardeners such as condensed polycyclic aromatic phenol resins based on a naphthalene skeleton, and phenol resins containing nitrogen and phosphorus. Furthermore, the curing accelerator for the epoxy resin increases the curing speed of the epoxy resin.

Such a curing accelerator can be appropriately used as long as it accelerates the curing of the epoxy resin, and the sort is not particularly limited.

According to the purpose of use, known fillers and reinforcing agents such as silica, talc, calcium carbonate, clay, elastomer, metal oxides such as titanium dioxide or alumina, glass fibers, carbon fibers, polyamide fibers and the like may be added to the magnet fixing resin 5 at any stage before curing. Furthermore, according to the purpose of use, colorants such as pigments or dyes, flame retardants, leveling agents and the like may be added to the magnet fixing resin 5 at any stage before curing.

The working oil 7 is used in order to prevent galling and burning, and is not particularly limited as long as it is used in machining, such as press oil, processing oil, cutting oil and the like. The main component may be mineral oil or synthetic oil, but highly refined light base oil is preferable. In addition, as an additive, an oily agent containing a polar functional group such as a carboxyl group, carbonyl group, hydroxyl group, ester, amine, or amide is preferably contained in an weight percentage of 1% or more, and more preferably 1 to 15%. The presence of a polar functional group can be confirmed by infrared absorption spectrum measurement of the working oil 7. Furthermore, as arbitrary components, a viscosity index improver, an extreme pressure additive, a solid lubricant, a rust inhibitor, an antiseptic and the like may be added.

The rotary electric machine of this embodiment manufactured as described above has an enhanced adhesive strength between the rotor core 1 and the magnet fixing resin 5, and has a resin shear strength that is 1.5 to 4.0 times that in the absence of the work oil 7. Furthermore, because the permanent magnets 3 can be firmly fixed to the rotor core 1, the rotor can be rotated at higher speeds.

Specific examples are shown below. However, the present embodiment is not limited to the following examples as long as it does not deviate from the gist of the embodiment.

A rotor core (diameter 140 mm, height 40 mm) with magnet slots was produced by stacking silicon steel plates (thickness 0.3 mm) with insulating films formed on the surfaces and by mechanically caulking them. As shown in FIG. 1, four magnet slots were provided, each 45 mm width and 8 mm length. As the work oil 7, punching work oil with a kinematic viscosity of 1.2 mm²/s (40° C.) containing 50% highly refined light base oil and 1-10% oiliness agent was applied to the entire rotor core.

Next, a rectangular parallelepiped (42 mm×7.5 mm×38 mm) neodymium-iron-boron sintered magnet with a zinc-plated surface was prepared. Next, a phenol-cured epoxy resin was prepared as the magnet fixing resin 5. This epoxy resin uses a phenol novolac-type phenolic resin as a curing agent, and contains silica of 70 to 80 weight percentage as a filler. By using a molding machine, the rotor core was injected and molded at a mold temperature of 170° C., injection pressure of 7 MPa, and a curing time of 2 minutes. The glass transition temperature of the magnet fixing resin after curing is 160° C. to 170° C., and the flexural modulus is 15 to 20 GPA. By producing as described above, sample 1 which is formed as the rotor for the IPM motor was completed.

For comparison, in the above-mentioned Sample 1 (Example 1), Sample 2 (Example 2) was created by using a shape in which the magnet slots of the rotor core were formed so as to have flux barriers as shown in FIG. 9. In Sample 2, the configuration is the same as that of Sample 1 described above, except that the magnet slots are provided with flux barriers.

For comparison, sample 3 (Example 3) was created by applying punching work oil to the surface of the permanent magnet in the above-mentioned sample 1. The configuration of sample 3 is the same as that of sample 1 except that the surface of the permanent magnet is provided with punching work oil.

For comparison, in the above-mentioned Sample 1, punching work oil was applied in advance between each of the iron core laminations when stacking the rotor core, and Sample 4 (Example 4) was created in a state in which the punching work oil was present between the iron core laminations. In Sample 4, the configuration other than the provision of the oil between the iron core laminations is the same as that of the above-mentioned Sample 1.

For comparison, sample 5 (Example 5) was created by applying punching work oil to the entire inner wall of the magnet slot in the above-mentioned sample 1. The configuration of sample 5 is the same as that of sample 1 except that punching work oil is applied to the entire inner wall of the magnet slot.

For comparison, sample 6 (Example 6) was created by applying the magnet fixing resin to the above-mentioned sample 1, and thereafter cleaning the rotor core surface by a solvent such as acetone or hexane. It is noted that the configuration of sample 6 is the same as that of sample 1, except for the state in which the rotor core surface is cleaned.

For comparison, Sample 7 (Comparative Example 1) was created without applying any punching work oil to the above-mentioned Sample 1. The configuration of Sample 7 is the same as that of Sample 1 except that no punching work oil is applied.

For comparison, Sample 8 (Comparative Example 2) was created without applying punching work oil in the above-mentioned Sample 1. Further in Sample 8, fingerprints or hand oil (grease) is attached to the interface between the rotor core and the magnet fixing resin. In Sample 8, there is no punching work oil at the interface between the rotor core and the magnet fixing resin, and the configuration is the same as that of Sample 1 described above, except that grease and the like are attached.

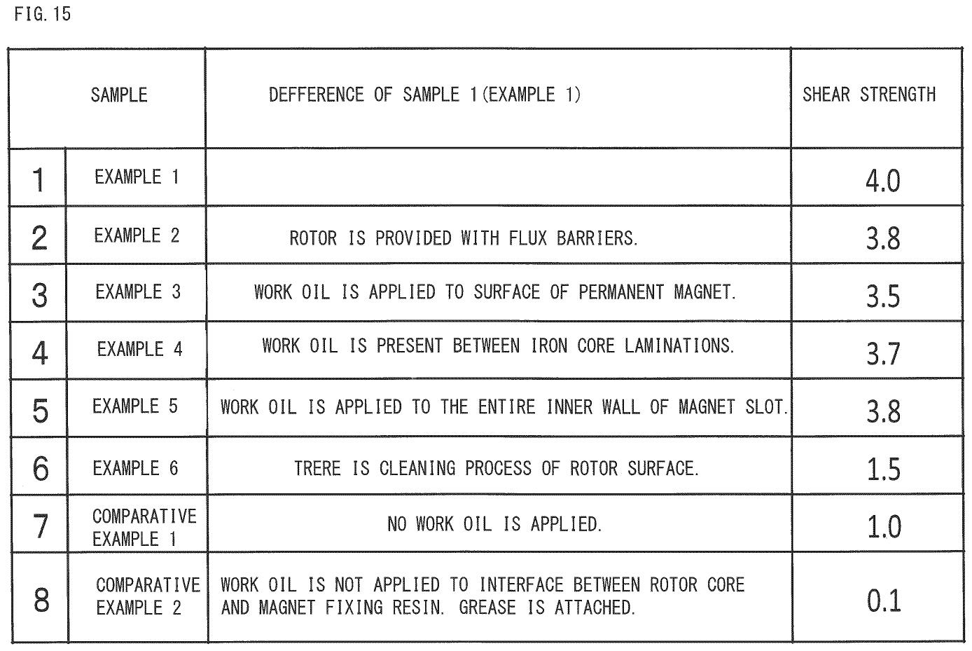

FIG. 15 is a table showing the relationship between each sample and shear strength, and shows the effect of the first embodiment.

Axial direction shear strength was evaluated by using the above-mentioned specimens 1 to 8 (Samples 1 to 8). The magnet slots were compressed by using a universal testing machine at room temperature, and the strength was recorded when fracture occurred between the rotor core and the magnet fixing resin, and between the magnet fixing resin and the permanent magnet.

FIG. 15 shows the shear strength (N/mm²) results for each sample. Samples 1 to 5 showed 3.5 to 4.0 multiples of the shear strength of Sample 7. Sample 6 showed 1.5 multiples of the shear strength of Sample 7. On the other hand, Sample 8 showed 0.1 multiples of the shear strength of Sample 6.

In samples 1 to 5, work oil 7 is present on the rotor core surface or the permanent magnet surface. The oiliness agent in work oil 7 has polar functional groups, so it is adsorbed to the substrate surface and forms a film of oiliness agent molecules. This molecular film also forms hydrogen bonds with the magnet fixing resin. As a result, it exhibited higher shear strength than the case in which work oil 7 is not applied.

In sample 6, the surface of the rotor core was cleaned by a solvent, but high shear strength was confirmed. Work oil 7 present on the stacked surface of the electromagnetic steel sheet seeped out to the interface with the adhesive surface, and the effect of improving shear strength was shown.

On the other hand, in sample 7, grease components derived from hand oil are present on the rotor core surface or permanent magnet surface. These grease components inhibited hardening of the adhesive interface or the formation of hydrogen bonds, and shear strength was decreased significantly.

The above results show that applying work oil 7 to the rotor core or permanent magnet surface improves the shear strength between the rotor core and the magnet fixing resin, and between the magnet fixing resin and the permanent magnet.

Furthermore, the work oil 7 may be applied to the magnet slots before the permanent magnets or magnet fixing resin are inserted into the magnet slots. Furthermore, the shear strength can be improved at the interface between the inner wall surface of the flux barrier portion of the rotor core and the magnet fixing resin filled in the flux barrier portion.

Furthermore, a structure in which the work oil is present at the entire interface between the rotor core and the magnet fixing resin can be efficiently obtained by relatively simple processes.

Furthermore, a process of applying work oil 7 as a surface treatment to the entire surface of the rotor core 1 may be provided prior to the process of adhesively fixing the permanent magnets 3 to the rotor core 1.

In other words, since the work oil 7 only needs to be present at the adhesive interface, it is possible to omit pretreatment processes such as degreasing, primer treatment, and UV (ULTRAVIOLET) irradiation, which are required in order to improve adhesive strength in the past. Therefore, the work oil 7 can be provided efficiently. Furthermore, the shear strength between the rotor core 1 and the magnet fixing resin 5 in the IPM motor can be improved.

Furthermore, prior to the process of adhesively fixing the permanent magnets 3 to the rotor core 1, a process of applying work oil 7 to the entire inner wall surface of the magnet slots 2 within the magnet slots 2 may be provided. By this way, it is possible to improve the shear strength of the IPM motor over the entire interface between the rotor core 1 and the magnet fixing resin 5. Furthermore, a process of applying work oil 7 to the inside of the magnet slots 2 may be carried out before the permanent magnets 3 or the magnet fixing resin 5 are inserted into the magnet slots 2, and a structure in which the work oil 7 is provided over the entire interface between the rotor core 1 and the magnet fixing resin 5 can be obtained efficiently by a relatively simple process.

Furthermore, processes described below may be provided prior to the process of adhesively fixing the permanent magnets 3 to the rotor core 1. That is, work oil 7 is applied to the entire surface of the rotor core 1 as a surface treatment. And after the process of applying the work oil 7 as a surface treatment, a cleaning process may be provided. In the cleaning process, the surface of the rotor core 1 is cleaned under conditions in which the work oil 7 remains on at least the adhesive surface between the rotor core 1 and the magnet fixing resin 5.

Even if the cleaning process is performed in this way, the remaining work oil 7 has the effect of improving the shear strength. By this way, it is possible to improve the shear strength between the rotor core 1 and the magnet fixing resin 5 in the IPM motor.

Furthermore, the rotor core 1 can be produced by a bonded steel sheet in which the stacked layers of the electromagnetic steel sheet are bonded and fixed by magnet fixing resin 5. Then, after the process of applying work oil 7 as a surface treatment, the process of bonding and fixing the permanent magnets 3 to the rotor core 1 can be performed without carrying out a cleaning process for removing organic matter on the surface of the rotor core 1.

By doing this, the shear strength of the rotor core 1 and the magnet fixing resin 5 can be efficiently improved in the IPM motor without carrying out pretreatment processes (degreasing, primer treatment, UV irradiation, etc.).

As a result of the above, by implementing this embodiment, the shear strength between the rotor core and the magnet fixing resin, and the shear strength between the magnet fixing resin and the permanent magnets, are improved. Therefore, even in a rotor that rotates at high speed, it is possible to provide a rotary electric machine in which the permanent magnets are firmly fixed by the magnet fixing resin.

Furthermore, by applying a coating process to the core surface by work oil 7, the shear strength of the magnet fixing resin is improved, and the durability of the rotor that rotates at high speed can be improved.

### Embodiment 2

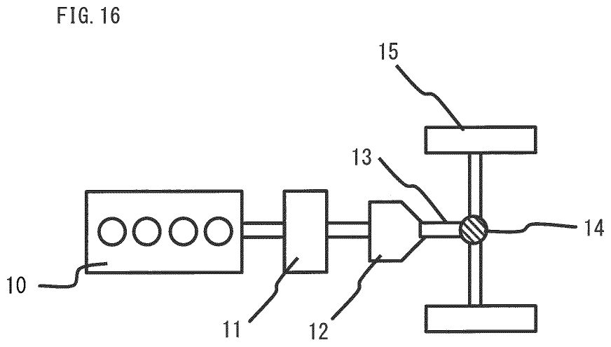

FIG. 16 is a schematic diagram showing the main parts of the drive system of a hybrid automobile (electric vehicle), and shows the state in which the rotary electric machine (IPM motor) shown in embodiment 1 is installed in the engine.

Hereafter, an embodiment in which the IPM motor shown in embodiment 1 is applied to the drive system of an automobile will be described. In FIG. 16, IPM motor 11 is installed between engine 10 and transmission 12 via drive shaft 13. Clutches may be interposed before and after the IPM motor 11. Furthermore, the power of the drive shaft 13 is transmitted to drive wheels 15 via a differential gear 14. A hybrid vehicle has two sorts of power sources, that is, a motor (IPM motor 11) and an engine. And the engine can be used continuously in an efficient state. In hybrid vehicles and electric vehicles, it is required to have higher output and smaller size. To achieve higher output and smaller size, it is necessary to improve durability at higher temperatures. By applying the rotor according to the first embodiment to hybrid vehicles and electric vehicles, it becomes possible to use the motor in a high-temperature environment for a long period of time, and it is possible to achieve a high-output and compact motor.

Although the disclosure is described above in terms of various exemplary embodiments and implementations, it should be understood that the various features, aspects, and functionality described in one or more of the individual embodiments are not limited in their applicability to the particular embodiment with which they are described, but they can be applied, alone or in various combinations to one or more of the embodiments of the disclosure.

It is therefore understood that numerous modifications which have not been exemplified can be devised without departing from the scope of the specification of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 Rotor core
2 Magnet slot
3 Permanent magnet
4 Shaft slot
5 Magnet fixing resin
7 Work oil
8 Stator core
9 Stator winding
10 Engine
11 IPM motor
12 Transmission
13 Drive shaft
14 Differential gear
15 Drive wheel

1.-14. (canceled)

15. A rotor for a rotary electric machine having a rotor core made of multiple stacked electromagnetic steel plates and a permanent magnet fixed to the rotor core via a magnet fixing resin,
wherein work oil is present on the adhesive surface between the rotor core and the magnet fixing resin.

16. The rotor for the rotary electric machine according to claim 15, wherein
a plurality of magnet slots are provided along the circumferential direction of the rotor core,
the permanent magnets are stored in the magnet slots and adhesively fixed to the inner wall surface of the magnet slots via the magnet fixing resin,
and the work oil is present on the inner wall surface.

17. The rotor for the rotary electric machine according to claim 16, wherein
the magnet slot is filled with the magnet fixing resin except for the portion occupied by the permanent magnet, and the work oil is present over the entire inner wall surface.

18. The rotor for the rotary electric machine according to claim 16, wherein
a flux barrier is provided in the magnet slot, and the work oil is present on an inner wall surface of the flux barrier.

19. The rotor for the rotary electric machine according to claim 15, wherein
the work oil is present on an adhesive surface between the permanent magnet and the magnet fixing resin.

20. The rotor for the rotary electric machine according to claim 15, wherein
the work oil is present between the laminations of the electromagnetic steel sheets that form the rotor core, and an adhesive steel sheet is used in which the laminations of the electromagnetic steel sheets are adhesively fixed each other by the magnet fixing resin.

21. The rotor for the rotary electric machine according to claim 15, wherein
the work oil contains an oiliness agent component containing a polar group.

22. The rotor for the rotary electric machine according to claim 15, wherein
a polar group provided in the work oil is a carboxyl group, a hydroxyl group, or an amine.

23. The rotor for the rotary electric machine according to claim 15, wherein
the work oil contains an oiliness agent component in a weight percentage of 1% or more.

24. The rotor for the rotary electric machine according to claim 15, wherein
the magnet fixing resin is an epoxy resin.

25. A method for manufacturing the rotor for the rotary electric machine according to claim 15, wherein
a process of applying the work oil as a surface treatment to the entire surface of the rotor core is provided prior to a process of adhesively fixing the permanent magnets to the rotor core.

26. A method for manufacturing the rotor for the rotary electric machine according to claim 16, wherein
a process of applying the work oil to the entire inner wall surface of the magnet slots is provided prior to a process of adhesively fixing the permanent magnet to the rotor core.

27. A method for manufacturing the rotor for the rotary electric machine according to claims 15, wherein
the work oil is applied to the entire surface of the rotor core as a surface treatment prior to adhesively fixing the permanent magnets to the rotor core,
and then the surface of the rotor core is cleaned under conditions in which the work oil remains on at least the adhesive surface between the rotor core and the magnet fixing resin.

28. A method for manufacturing the rotor for the rotary electric machine according to claim 20, wherein
the permanent magnets are adhesively fixed to the rotor core without performing a cleaning process for removing organic matter on the surface of the rotor core after the work oil is applied as a surface treatment.

29. The rotary electric machine comprising:
the rotor according to claim 15; and a stator disposed on an outer periphery of the rotor.

30. An electric vehicle using the rotary electric machine according to claim 29.

31. The rotor for the rotary electric machine according to claim 16, wherein
the work oil is present on an adhesive surface between the permanent magnet and the magnet fixing resin.

32. The rotor for the rotary electric machine according to claim 17, wherein
the work oil is present on an adhesive surface between the permanent magnet and the magnet fixing resin.

33. The rotor for the rotary electric machine according to claim 18, wherein
the work oil is present on an adhesive surface between the permanent magnet and the magnet fixing resin.

34. The rotor for the rotary electric machine according to claim 16, wherein
the work oil is present between the laminations of the electromagnetic steel sheets that form the rotor core, and an adhesive steel sheet is used in which the laminations of the electromagnetic steel sheets are adhesively fixed each other by the magnet fixing resin.
